(19) United States
(12) Patent Application Publication
(10) Pub. No.: US 2005/0032510 A1
(43) Pub. Date: Feb. 10, 2005

(54) System and a method of controlling mobile communication terminals using global positioning system

(75) Inventors: Jang Hyun Ryu, Seoul (KR); Gyoun Yon Cho, Seoul (KR)

Correspondence Address: Charles N.J. Ruggiero, Esq.;Ohlandt, Greeley, Ruggiero & Perle, L.L.P., 10th Floor, One Land mark Square, Stamford, CT, 06901-2682, US

(73) Assignee: PANTECH CO., LTD.

(21) Appl. No.: 10/867,881

(22) Filed: Jun. 15, 2004

(30) Foreign Application Priority Data
Aug. 7, 2003 (KR) 10-2003-0054668

(51) Int. Cl. H04M 3/00

(52) U.S. Cl. 455/419; 455/418

(57) ABSTRACT

According to the present invention, a system and a method of controlling mobile communication terminals using global positioning system (GPS) are provided. According to the present invention, the method includes: generating a GPS signal at a GPS signal generator; receiving the GPS signal from the GPS signal generator; extracting control information from the GPS signal; and converting use modes of the mobile communication terminal by using the control information. Accordingly, use modes of the mobile communication terminal located in a place required to restrict some functions of the mobile communication terminal can be collectively and automatically converted without additional costs.

### CROSS-REFERENCE TO RELATED APPLICATION

The entire disclosure of Korean Patent Application No. 10-2003-0054668 filed on Aug. 7, 2003 including specification, claims, drawings and summary, is incorporated herein by reference in its entirety.

### BACKGROUND OF THE INVENTION

1. Field of the Invention

The present invention relates to a system and a method of controlling mobile communication terminals, and more particularly to a system and a method of controlling mobile communication terminals which may convert use modes of the mobile communication terminals by using global positioning system (GPS).

2. Description of the Related Art

Popularization of mobile communication terminals such as a cellular phone due to development of information and communication environments causes daily activity as well as the communication environments to be changed. In addition, current mobile communication terminals have been improving users' convenience by adding more diverse functions.

Meanwhile, as mobile communication terminals are popularized, bad effects of using mobile communication terminals occur. For example, telephone rings in public places such as auditoriums and classrooms, cheating is done by sending messages during examination, or critical information is leaked by using camera functions of cellular phones. Accordingly, it is required to impose restrictions on use of the mobile communication terminals depending on purposes or degrees of importance of security of places in which the mobile communication terminals are carried. However, there's no way to impose restrictions on improper use of the mobile communication terminals according to the Related Art of controlling the mobile communication terminals, except for temporarily keeping the mobile communication terminals in custody or keeping a close watching over use of the mobile communication terminals. Additionally, other people may be damaged by users' carelessness.

Recently, mobile communication terminals equipped with global positioning system (GPS) module using satellite communication are developed and popularized. In the GPS, 4˜5 GPS satellites are located in each of six planes of orbits having an incline of 55 degrees with the Equator. GPS makes it possible to communicate with four or more GPS satellites anywhere on the Earth, and to calculate current position (longitude, latitude and altitude) at a point of time by receiving a signal having a specified code transmitted from the GPS satellites.

Accordingly, the present invention has been made to solve the above-mentioned problems occurring in the Related Art. An object of the present invention is to provide a system and a method of controlling mobile communication terminals which may convert use modes of the mobile communication terminals by using GPS.

### BRIEF SUMMARY OF THE INVENTION

In order to accomplish these objects, according to one embodiment of the present invention, there is provided a method of controlling mobile communication terminals using global positioning system (GPS), may include: generating a GPS signal at a GPS signal generator; receiving the GPS signal from the GPS signal generator; extracting control information from the GPS signal; and converting use modes of a mobile communication terminal by using the control information.

The GPS signal generator may be located in a place that is not influenced by a signal sent from a GPS satellite.

The control information may be one included in the GPS signal, and may include at least one of altitude information, latitude information, longitude information and time information.

Said converting use modes of a mobile communication terminal may be to convert use mode of the mobile communication terminal into one use mode of a plurality of use modes corresponding to the extracted control information.

The use modes may be set up to control at least one of loudness of ring tone, conversion between ring tone/vibration modes, image storage/reproduction, call transmission/reception, message transmission/reception, internet connection and file downloading of the mobile communication terminal.

Said extracting control information may be to demodulate the GPS signal into data which can be processed in the mobile communication terminal.

Differently, there is provided a system of controlling mobile communication terminals using global positioning system (GPS), including: a GPS signal generator, located in a place that is not influenced by a signal sent from a GPS satellite, generating and sending a GPS signal to a mobile communication terminal; and the mobile communication terminal, receiving the GPS signal from the GPS signal generator and extracting control information from the GPS signal, of which use modes are converted according to the control information.

The control information may be one included in the GPS signal, and may include at least one of latitude information, longitude information, altitude information and time information.

The mobile communication terminal may include: a GPS receiver receiving the GPS signal; a GPS decoder demodulating the received GPS signal and thus extracting the control information; and a GPS controlling part sending the control information to a micro computer unit of the mobile communication terminal and converting the use modes.

The use modes may be set up to control at least one of loudness of ring tone, conversion between ring tone/vibration modes, image storage/reproduction, call transmission/reception, message transmission/reception, internet connection and file downloading of the mobile communication terminal.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates structure of a system of controlling mobile communication terminals using GPS according to the present invention;

FIG. 2 illustrates internal construction of the mobile communication terminal illustrated in FIG. 1; and

FIG. 3 is a flowchart illustrating a method of controlling mobile communication terminals using GPS according to the invention.

### DETAILED DESCRIPTION OF THE INVENTION

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

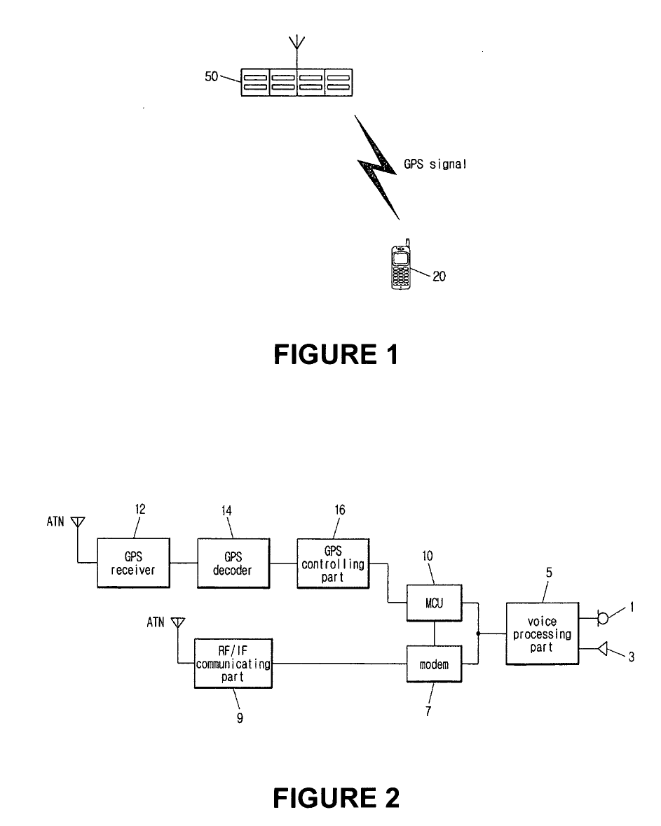

FIG. 1 illustrates structure of a system of controlling mobile communication terminals using GPS according to the present invention. As illustrated in FIG. 1, the system of the present invention includes a GPS signal generator 50 and a mobile communication terminal 20 of which use modes may be converted according to control information included in a signal generated from the GPS signal generator 50 (“GPS signal”).

The GPS signal generator 50, separately from the GPS satellite, self-generates GPS signals in a place (e.g. a room), which a signal generated from a GPS satellite (“GPS satellite signal”) does not successfully reach. Further, the GPS signal is set up previously according to characteristics of a room equipped with the GPS signal generator 50. Thus, there is no mutual influence between the GPS satellite signal and the GPS signal generated from the GPS signal generator 50 in the room.

The GPS signal may include peculiar control information (e.g. latitude information, longitude information, altitude information, time information, etc.) to take advantage of GPS module provided in mobile communication terminals, as with the GPS satellite signal. However, it is not necessary for the GPS signal to include all control information, for taking advantage of the GPS module. That is, even though the GPS signal includes only altitude information, use modes of mobile communication terminals can be converted, by taking advantage of the GPS module.

The mobile communication terminal 20 receives the GPS signal from the GPS signal generator 50, and converts use modes to control some functions, such as reducing loudness of ring tone, converting a ring tone mode into a vibration mode, or turning on/off camera functions, depending on the altitude information included in the received GPS signal.

As illustrated in FIG. 2, the mobile communication terminal 20 of the system according to the present invention includes a RF/IF communicating part 9, a modem 7, a voice processing part 5 having a microphone 1 and a speaker 3, and a micro computer unit (MCU) 10 controlling general functions of the mobile communication terminal 20.

In addition, the mobile communication terminal 20 includes a GPS receiver 12 receiving a GPS signal from the GPS signal generator 50, a GPS decoder 14 converting the received GPS signal into data, and a GPS controlling part 16 which determines a corresponding use mode according to the control information included in the converted data sent from the GPS decoder 14 and converts use mode of the mobile communication terminal 20 by sending the control information to the MCU 10. A GPS module of the mobile communication terminal includes the GPS receiver 12, the GPS decoder 14 and the GPS controlling part 16.

The use modes can be diversely defined. For example, in order to restrict use of some functions according to purposes or degrees of importance of security of places in which the GPS signal generators 50 are provided, diverse use modes that restricts loudness of ring tone, converts a ring tone mode into a vibration mode, or restricts functions of storing/reproducing moving images and stationary images including camera functions can be defined, according to the control information. In addition, according to types of the control information, use modes restricting call transmission/reception, restricting message transmission/reception, restricting internet connection and file downloading can be also defined.

The GPS signal transmitted from the GPS signal generator 50 is received in the GPS receiver 12 of the mobile communication terminal 20, and the received GPS signal is sent to the GPS decoder 14. The GPS decoder 14 extracts control information by demodulating the GPS signal and converting the demodulated signal into data that can be processed in the GPS controlling part 16, and sends the extracted control information to the GPS controlling part 16. Based on the control information, the GPS controlling part 16 converts use mode of the mobile communication terminal into certain use mode that is defined by considering purposes or degrees of importance of security of corresponding place. As a result of that, some functions of the mobile communication terminal are restricted.

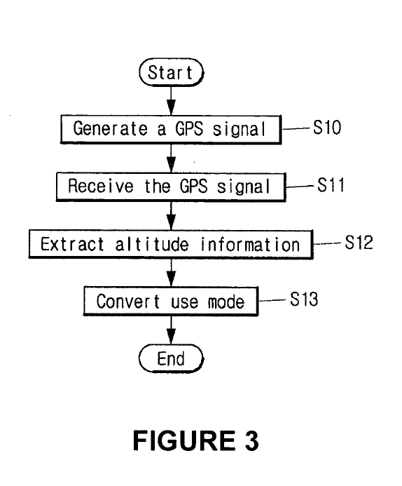

FIG. 3 is a flowchart illustrating a method of controlling the mobile communication terminal 20 using GPS as described above. FIG. 3 illustrates a method using altitude information of various control information included in the GPS satellite signal.

The GPS signal generator 50 which is provided in a certain place (e.g. a room), self-generates and sends a GPS signal. The GPS signal includes control information, in particular altitude information, to convert use modes of the mobile communication terminal. The GPS signal generator can send a GPS signal including altitude information previously defined by user according to characteristics of the place in which the GPS signal generator is provided.

First, the GPS signal generator generates a GPS signal including the altitude information (S10), and sends the GPS signal to the mobile communication terminal. Accordingly, the GPS receiver of the mobile communication terminal receives the GPS signal (S11).

In the mobile communication terminal, the altitude information is extracted from the received GPS signal (S12), and use mode of the terminal is, based on use modes previously defined according to the altitude information, converted into a use mode adapted to the extracted altitude information (S13).

The use modes of the mobile communication terminal can be previously set up in designing a system, and for example, can be classified into a first use mode, a second use mode, a third use mode and a fourth use mode.

The first use mode corresponds to a case of which altitude indicated by the altitude information is 10,000 meter˜20,000 meter. In the first use mode, a ring tone mode is converted into a vibration mode, and camera functions can not be used by restricting functions of storing/reproducing images.

The second use mode corresponds to a case of which altitude indicated by the altitude information is 20,000 meter˜30,000 meter. In the second use mode, although a ring tone mode is not converted into a vibration mode, loudness of the ring tone is reduced by two levels, and camera functions cannot be used by restricting functions of storing/reproducing images.

The third use mode corresponds to a case of which altitude indicated by the altitude information is 30,000 meter˜40,000 meter. In the third use mode, loudness of the ring tone is reduced by one level, and functions of storing/reproducing images can be used. Accordingly, camera functions can be used.

The fourth use mode corresponds to a case of which altitude indicated by the altitude information is 40,000 meter or more. In the fourth use mode, general functions of the mobile communication terminal can be freely used, and there is no special restriction on functions.

The conversion of use modes of the mobile communication terminal depending on the altitude information can be easily embodied merely by modifying software of the mobile communication terminal equipped with the GPS module.

The range of altitude indicated by the altitude information, contents of use modes according to the altitude, the number of use modes, types of control information influencing on conversion of use modes, and the number of control information influencing on conversion of use modes can be changed according to system set up, and thus are only illustrative. The present invention is not restricted by the above-mentioned numeral values, contents of use modes according to the altitude, the number of use modes and the conversion of the use modes.

As described above, according to the present invention, the GPS signal generator, which generates and sends the GPS signal, is provided in a predetermined place and the mobile communication terminal converts use modes according to the control information, in particular altitude information, included in the GPS signal. Accordingly, use modes of the mobile communication terminal located in the place required to restrict some functions of the mobile communication terminal can be collectively and automatically converted.

The foregoing embodiments are merely exemplary and are not to be construed as limiting the present invention. Many alternatives, modifications and variations will be apparent to those skilled in the art.

1. A method of controlling mobile communication terminals using global positioning system (GPS), comprising:
generating a GPS signal at a GPS signal generator;
receiving the GPS signal from the GPS signal generator;
extracting control information from the GPS signal; and
converting use modes of a mobile communication terminal by using the control information.

2. The method according to claim 1, wherein the GPS signal generator is located in a place that is not influenced by a signal sent from a GPS satellite.

3. The method according to claim 1, wherein the control information is one included in the GPS signal, and comprises at least one of altitude information, latitude information, longitude information and time information.

4. The method according to claim 1, wherein said converting use modes of a mobile communication terminal is to convert use mode of the mobile communication terminal into one use mode of a plurality of use modes corresponding to the extracted control information.

5. The method according to claim 1, wherein the use modes are set up to control at least one of loudness of ring tone, conversion between ring tone/vibration modes, image storage/reproduction, call transmission/reception, message transmission/reception, internet connection and file downloading of the mobile communication terminal.

6. The method according to claim 1, wherein said extracting control information is to demodulate the GPS signal into data which can be processed in the mobile communication terminal.

7. A system of controlling mobile communication terminals using global positioning system (GPS), comprising:
a GPS signal generator, located in a place that is not influenced by a signal sent from a GPS satellite, generating and sending a GPS signal to a mobile communication terminal; and
the mobile communication terminal, receiving the GPS signal from the GPS signal generator and extracting control information from the GPS signal, of which use modes are converted according to the control information.

8. The system according to claim 7, wherein the control information is one included in the GPS signal, and comprises at least one of latitude information, longitude information, altitude information and time information.

9. The system according to claim 7, wherein the mobile communication terminal comprises:
a GPS receiver receiving the GPS signal;
a GPS decoder demodulating the received GPS signal and thus extracting the control information; and
a GPS controlling part sending the control information to a micro computer unit of the mobile communication terminal and converting the use modes.

10. The system according to claim 7, wherein the use modes are set up to control at least one of loudness of ring tone, conversion between ring tone/vibration modes, image storage/reproduction, call transmission/reception, message transmission/reception, internet connection and file downloading of the mobile communication terminal.
